(19) United States
(12) Patent Application Publication
(10) Pub. No.: US 2003/0037592 A1
(43) Pub. Date: Feb. 27, 2003

(54) Gas chromatograph oven assembly

(75) Inventors: Silvester D'Couto, Austin, TX (US); Edward McCauley, Cedar Park, TX (US)

Correspondence Address: Aldo J. Test, FLEHR HOHBACH TEST ALBRITTON & HERBERT LLP, Suite 3400, Four Embarcadero Center, San Francisco, CA, 94111-4187, US

(73) Assignee: THERMO FINNIGAN LLC

(21) Appl. No.: 09/934,972

(22) Filed: Aug. 21, 2001

(51) Int. Cl. G01N 30/90; G01N 30/02

(52) U.S. Cl. 73/23.35

(57) ABSTRACT

A chromatographic oven assembly is described. The assembly includes an oven which is machined or formed from a low thermal mass material such as a silica/ceramic composite to form a cylindrical oven cavity. The capillary column is supported in a helical configuration in the oven cavity spaced from the walls with the ends extending through the insulating material for introduction of sample mixture and detection of the separated components of the mixture. An electric heater and a fan are mounted in a separate module and introduce heated air through a tangential opening, and receive air after it has circulated in the oven through a tangential opening. Air is continuously heated and circulated to maintain the column at the elevated temperature. For cooling, the heater is bypassed and cool ambient air is introduced tangentially into the oven by the fan and expelled to the atmosphere. In another embodiment, the fan and heater are mounted in the oven cavity.

### BRIEF DESCRIPTION OF THE INVENTION

The invention relates generally to oven assemblies for heating and cooling gas chromatographic columns and more particularly to ovens having an oven cavity defined by low thermal mass rigid composite insulating material walls.

### BACKGROUND OF THE INVENTION

In the field of gas chromatography, chromatographic columns are placed in an oven which gradually heats the column in which the constituents of the mixture to be analyzed are separated as the mixture flows through the column. The constituents are detected as they leave the column. The temperature in the oven is controlled to maintain the column at a preselected temperature. Generally, the separation is carried out at elevated temperatures, as high as 450° C. The oven is cooled to room temperature to replace columns or change columns. Generally, the air within the oven is heated with an electric heating element placed within the oven and circulated with a fan to uniformly heat or cool the interior of the oven and the column. Cooling is generally accomplished by circulating ambient air from the surrounds through the oven.

Prior art ovens have a rectangular or square interior with a metal lining. The oven walls are insulated with insulating material such as fiberglass or ceramic wool blankets retained between an inner metal lining and outer metal walls. The metal lining adsorbs heat, increasing the cooling time. The square or rectangular shape of the oven interior makes it difficult to uniformly heat the oven. Heating time is increased as is the cooling time, because of the large thermal mass of the oven interior. These ovens are generally limited to 450° C. due to the rapid oxidation and discoloration of the metal lining above this temperature. It is desirable to extend the temperature consistent with the capabilities of capillary columns which can withstand temperatures as high as 485° C. Even though the insulation is contained within metal walls, over time, particles of the material come loose and migrate. Fabrication of the ovens is time-consuming and expensive because of the many parts that are required.

There is a need for an oven for chromatographic columns which is easy to fabricate, has low thermal mass whereby the heating and cooling cycles are shortened, and in which the air within the oven is effectively and efficiently circulated to maintain the column at a uniform temperature throughout its length. A separate heating and cooling module for circulating hot and/or cold air through the oven is desirable so that ovens can be easily interchanged.

### OBJECTS AND SUMMARY OF THE INVENTION

It is an object of the present invention to provide an easily fabricated, low thermal mass, efficiently cooled chromatograph oven assembly.

It is a further object of the present invention to provide an oven assembly which is configured to uniformly and quickly heat or cool a chromatographic column mounted in the oven.

It is a further object of the present invention to provide an oven assembly in which the walls are formed from a low thermal mass rigid composite insulating material.

It is another object of the present invention to provide an easily fabricated, low thermal mass, efficiently cooled oven and a heating and cooling assembly or module for circulating hot air through the oven at temperatures up to 500° C.

The chromatographic oven assembly of the present invention includes an oven which is machined or formed from a low thermal mass rigid composite insulating material such as a silica/ceramic composite to form a cylindrical oven cavity. The capillary column is supported in a helical configuration in the oven cavity spaced from the walls with the ends extending through the insulating material for introduction of sample mixture and detection of the separated components of the mixture. An electric heater heats air and a fan circulates the heated air in the oven to maintain the column at the elevated temperature. For cooling, cool ambient air is introduced tangentially into the oven through an opening in the oven wall by the fan and expelled to the atmosphere through another opening. In one embodiment, the heater and fan are in the oven cavity, while in another preferred embodiment the heater and fan are outside the oven cavity.

### BRIEF DESCRIPTION OF THE DRAWINGS

The invention will be more clearly understood from the following description when it is read in connection with the accompanying drawings in which:

FIG. 1 is a front elevational view of an oven assembly in accordance with one embodiment of the present invention with the front enclosure removed.

FIG. 2 is a sectional view of the oven shown in FIG. 1 taken along the line 2-2.

FIG. 3 is a perspective view of the oven assembly showing air inlet and outlet openings.

FIG. 4 is a perspective view of a gas chromatograph and oven assembly in accordance with another embodiment of the present invention.

FIG. 5 is a perspective view of the oven cavity and oven heating and cooling assembly of FIG. 4 in the heating mode.

FIG. 6 is a perspective view of the oven cavity and oven heating and cooling assembly of FIG. 4 in the cooling mode.

### DESCRIPTION OF THE PREFERRED EMBODIMENT

Referring to the figures, the oven is defined by walls 12 of cavity or interior 11 of low thermal mass rigid composite insulating material. Rigidized insulation materials developed for re-entry space vehicles are eminently suitable for use for walls of gas chromatograph ovens. These insulation materials are structurally rigid, can handle temperatures as high as 1200° C. and have low densities, ranging from 6 to 22 pounds per cubic foot. The low density requirement as an aerospace material results in a low thermal mass which is used to advantage in the design of a fast ramping and/or low peak power gas chromatograph. The aforementioned insulating materials are composed solely or chiefly of a high purity silica fiber matrix to which a lower quantity of alumina fibers or aluminum borosilicate fibers may be added to obtain the desired properties. The composited matrix is then sintered at high temperatures in order to obtain a rigid form. The matrix may also contain lower quantities of opacifying and/or emittance agents to further enhance the insulation properties. Examples of such insulation are LI-2200, LI-900, HTP, FRCI-12, AETB12, AETB-8 and TUFI, developed by Lockheed Missile and Space Corporation, NASA/Ames Research Center and Rockwell International. The HTP material is described in a NASA tech brief “High Strength, Low-Shrinkage Ceramic Tiles” Winter 1985, Vol. 9, No. 4, MSC-20654.

The preferred material is a 6-pound-per-cubic-foot HTP (High Temperature Performance) formulation supplied by Ecesis Corporation of Lafayette, In. This material has low thermal mass while maintaining sufficient structural integrity. The surface of this material is treated with a refractory coating to improve impact or abrasion resistance and to prevent inhalation of fines generated in the machining of the cavity. Alternatively, the material can be molded to shape the oven. Since the walls of the cavity are defined by the rigid composite insulating material, the hot load is reduced, thereby reducing the heating and cooling time as compared to the prior art metal-lined ovens. The cavity 11 is preferably cylindrical, thereby reducing the surface area and volume of the cavity as compared to square or rectangular oven cavities, further decreasing the heat load and therefore the heating and cooling time.

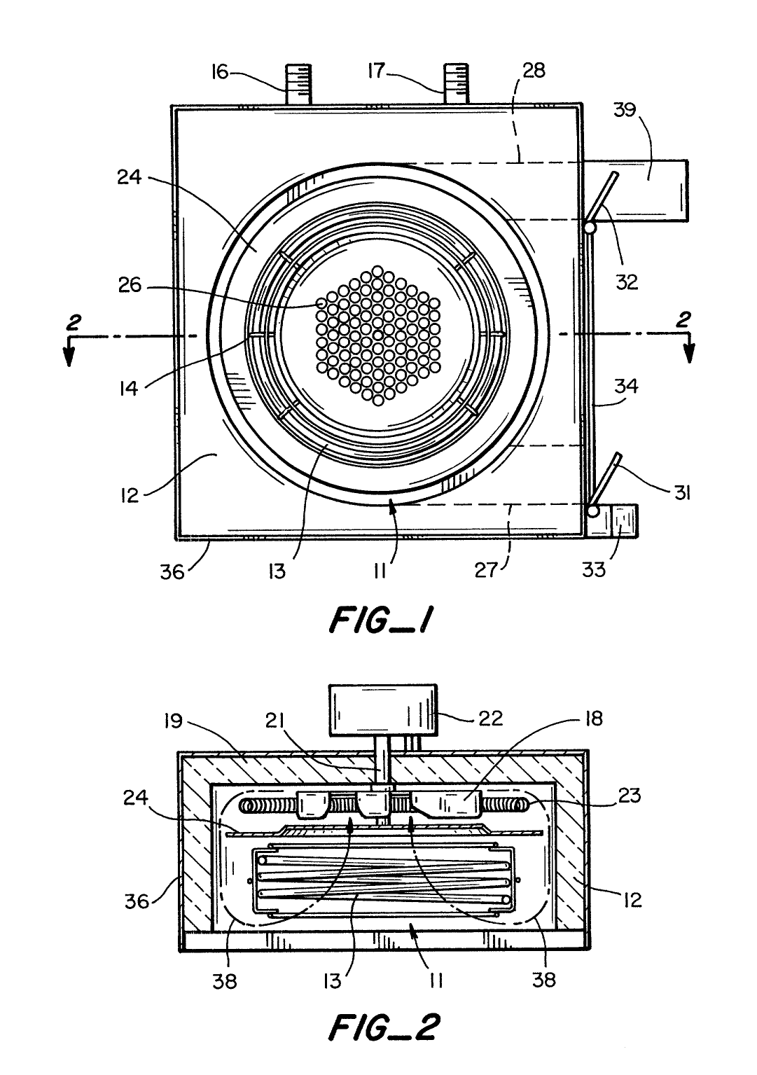

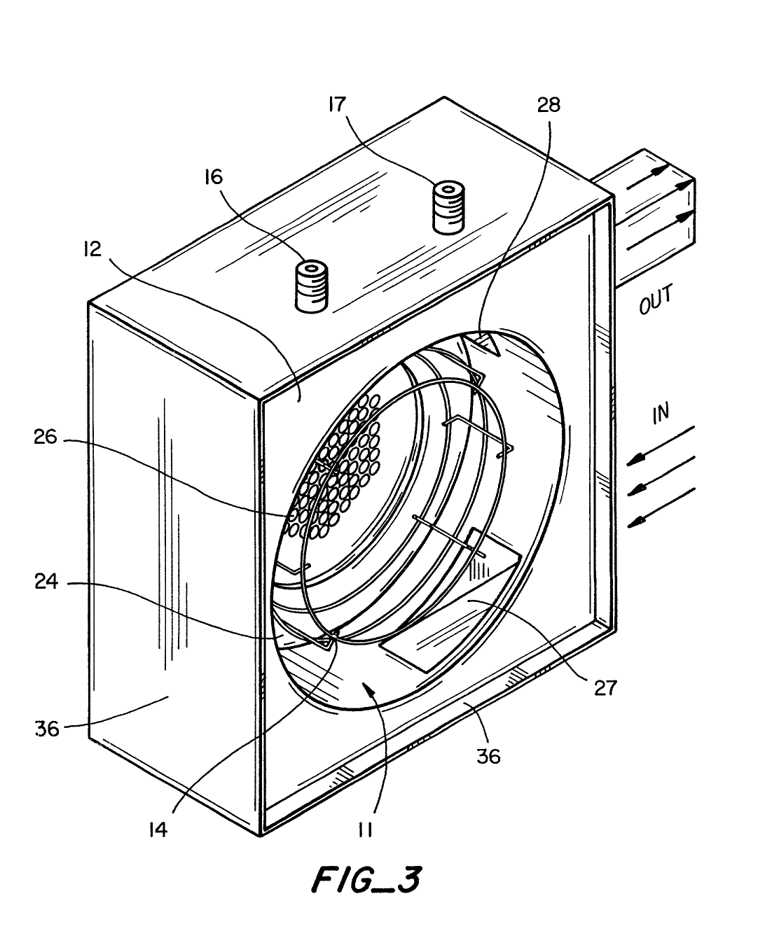

A first embodiment of the invention employing an oven constructed with rigidized composite insulating material is described with reference to FIGS. 1-3. The oven includes walls 12 defining the cavity 11. A helically-wound capillary column 13 is supported spaced from the walls of the oven interior by brackets 14. The ends 16 and 17 of the column extend through the wall to provide an inlet for the introduction of sample into the column and to detect the separated components of the sample. A fan 18 is supported adjacent the back wall 19 by a shaft 21 which extends through the wall. The fan is driven by a motor 22. A heater coil 23 is supported between the back wall 19 and the fan 18. A baffle plate 24 having apertures 26 is supported in front of the fan 18. The oven includes an air inlet passage 27 extending through the wall in the front portion of the oven cavity in front of the baffle 24 and an air outlet passage 28 at the rear of the oven cavity. Hinged flaps 31 and 32 are mounted at the outer ends of the passages 27 and 28, respectively. The flaps are controlled by a motor 33 which drives the rod 34 coupled to a gear mechanism, not shown, to rotated the flaps to selectively open or close the passages. The oven may be provided with a protective metal housing 36 which extends beyond the front surface of the oven to receive a closure or door 37, FIG. 2, made of the same low thermal mass rigid composite insulating material.

The column is heated by applying power to the motor to rotate the shaft and fan and power to the heater coil. The fan circulates the air in a toroidal pattern 38 over the heater element and over the helically-wound column to rapidly and uniformly heat the column. As discussed above, the heating is rapid because of the small heat load provided by the shape of the oven and absence of a metal lining.

The column is rapidly cooled by turning off the heater and opening the flaps 31 and 32 so that ambient cool air is drawn into the interior through passage 27 and flows past the helically-wound column and is expelled through passage 28. A conduit 39 directs the hot air away from the oven.

In another embodiment of the invention, the fan and heater are located in a module external of the oven interior to permit higher operating temperatures because of the lower heat load due to the absence of any metal parts in the oven. In addition, because the oven is separate, it can be rapidly exchanged. Operator safety is increased because the oven itself does not contain the metal, heater, shroud, fan, etc.

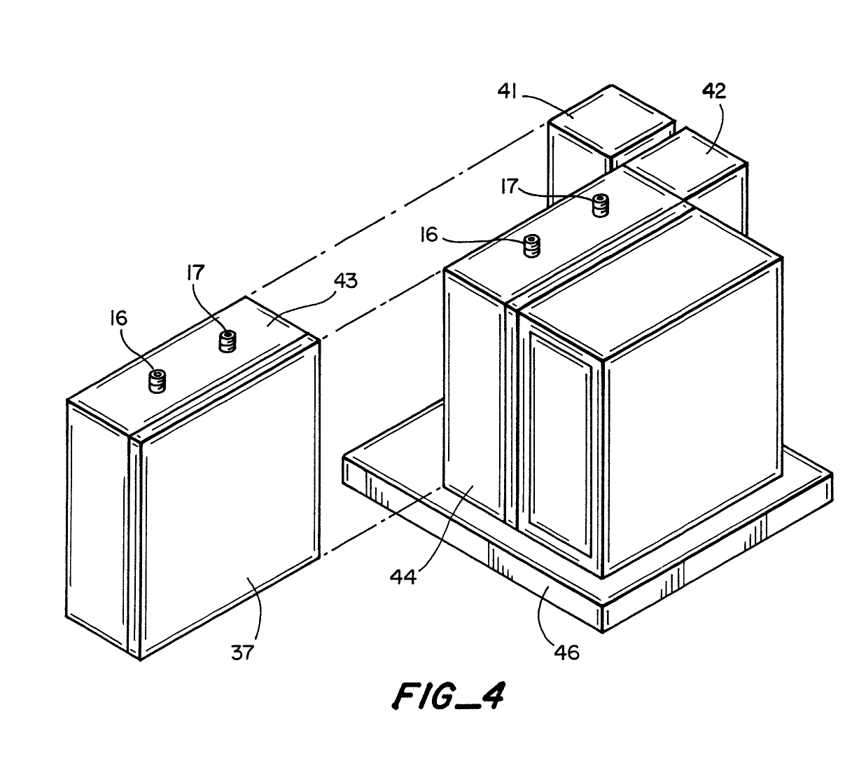

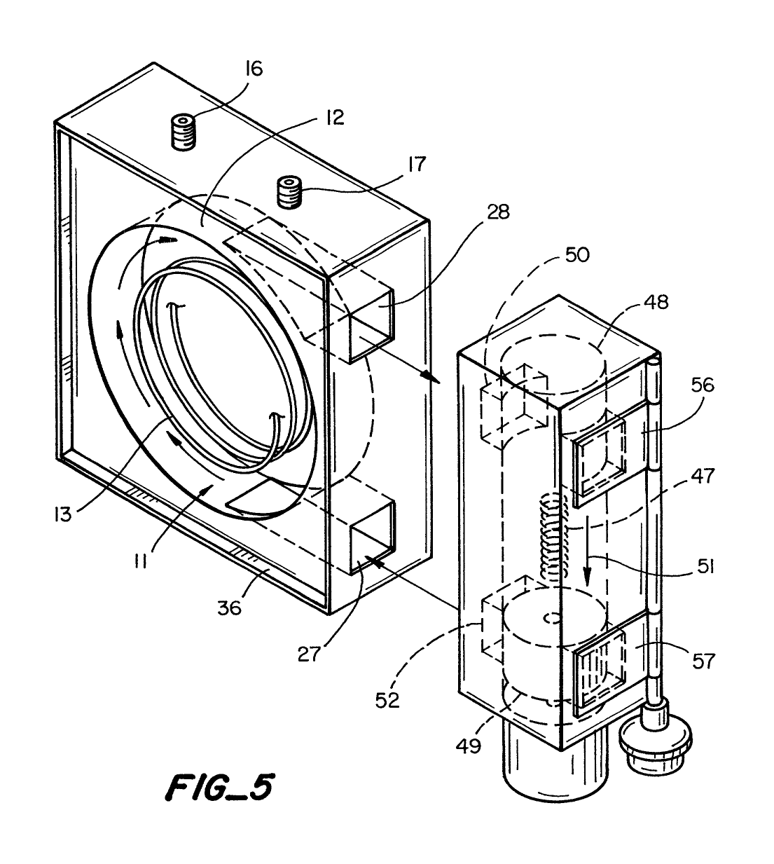

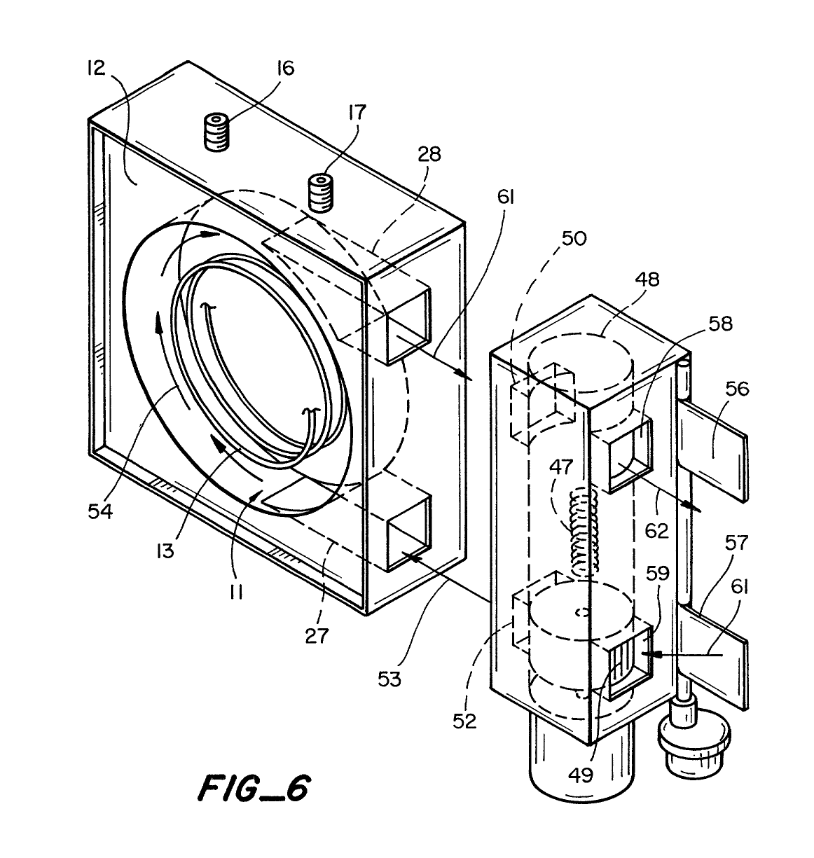

FIGS. 4-6 show a chromatograph which includes heater and fan modules 41 and 42 for circulating heated or ambient air through the cavity of removable oven modules 43 and 44.

The chromatograph includes a base 46 which houses the required power supply and electronics to operate the chromatograph. The oven modules 43 and 44 are removably mounted on the base 46 in cooperative relationship with the heating and cooling modules 41 and 42. The provision of two ovens permits analysis of certain chemical compounds in which it is necessary to use more than one column so that the columns can be maintained at different temperatures, commonly known as multidimensional chromatography. When two oven modules are installed, the electronic controls are shared. Although a chromatograph using two oven modules is described, it is apparent that it may include a single oven module or more than two oven modules. The oven modules, except for the absence of heater, fan and motor, are constructed substantially as described above, and like reference numerals have been applied to like parts of the oven module. Since the oven module includes the inlet, column and outlet, it can be easily removed from the chromatograph for servicing while the heating and cooling module remain with the chromatograph. Application-dependent oven modules are easily swappable.

Heating and/or cooling air is supplied by the heating and cooling modules 41 and 42. Each module includes an electric heating element 47 disposed in a cylindrical housing 48. A fan 49 is located at one end of the housing. In the heating mode, air is drawn into the housing from the oven cavity through the passage 28 and into the housing through the opening 50. It is then drawn downwardly by the fan, as shown by arrow 51, and flows through the opening 52 and through passage 27 in the heating/cooling module, arrow 53, and circulates in a circular fashion, arrows 54, in the oven cavity. As the air is circulated, it is heated to the desired temperature by the heating element. The power applied to the heating element is controlled by the electronic circuitry in order to maintain a desired temperature. As described above, the circulation is such as to assure uniform column temperature.

In the cooling mode, the doors 56 and 57 are opened so that the openings 58 and 59 communicate with the surrounds. The heater is turned off. The fan draws room-temperature ambient air, arrow 61, from the surrounds, and directs it into the opening 59 through opening 52 and passage 27 where it circulates in the oven and picks up heat, thereby cooling the column. The heated air is discharged, arrow 61, through the opening 58 into the surrounds. As described above, the cooling is rapid because of the low heat capacity of the oven.

An oven constructed with low thermal mass silica/ceramic materials was operated with a heating and cooling module of the type described. Its heating and cooling rates were found to be substantially higher than those of currently available ovens.

Thus, there has been provided a chromatographic apparatus with an oven which provides a low heat load. The oven is rapidly and efficiently heated and cooled. The modular construction provides a simple oven which can be easily removed, serviced or replaced. The modular construction permits operation of a plurality of ovens at different or the same temperature under control of common electronic circuitry.

The above-described embodiments of the invention are merely illustrative of the invention. Various modifications and enhancements can be introduced by those knowledgeable in the field without departing from the spirit and scope of the present invention, which is embodied in the appended claims.

What is claimed is:

1. A gas chromatograph oven assembly including:
low thermal mass rigid composite insulating material forming the oven cavity, and
a chromatographic column mounted within said oven cavity.

2. A gas chromatograph oven assembly as in claim 1 in which said oven cavity is cylindrical and said chromatographic column is helically wound and spaced from the wall of said cylindrical cavity.

3. A gas chromatograph oven assembly as in claims 1 or 2 including a fan for circulating air in said cavity.

4. A gas chromatograph oven assembly as in claim 3 in which the fan is mounted within said cavity for toroidally circulating the air over said column.

5. A gas chromatograph oven assembly as in claim 3 in which the fan is mounted external to said cavity in an external passageway, and
said oven includes passages in said wall in communication with said external passageway so that air can be circulated through said cavity by said fan.

6. A gas chromatograph oven assembly as in claim 4 including a heater mounted in said cavity adjacent said fan for heating the circulating air.

7. A gas chromatograph oven assembly as in claim 5 including a heater mounted in said external passageway in cooperative relationship to said fan whereby the air circulated by said fan is heated by the heater.

8. A gas chromatograph oven assembly as in claim 4 including spaced passageways in said oven wall communicating with the surrounds whereby when said passageways are open, cooling air is drawn into the oven cavity through one passageway and expelled into the surrounds from the other, whereby the cavity and column are cooled by the circulated ambient air.

9. A gas chromatograph oven assembly as in claim 5 in which said external passageway is opened to the surrounds so that the fan can draw cooling air from the surrounds, circulate it through the oven cavity and expel it to the surrounds.

10. A gas chromatograph oven assembly including:
a passageway having an inlet and an outlet port,
a fan mounted in said passageway,
a heater mounted in said passageway,
an oven having a cavity defined by an insulated housing, said oven adapted to be placed in cooperative relationship with said passageway,
a chromatographic column mounted in said oven cavity, and
passages in said oven communicating with said passageway inlet and outlet ports whereby when said oven is placed in cooperative relationship which said passageway air can be circulated through said passageway and oven cavity by the fan.

11. A gas chromatograph oven assembly as in claim 10 in which the oven housing is low thermal mass rigid composite material.

12. A gas chromatograph oven assembly as in claim 10 or 11 in which the cavity is cylindrical.
